(19) United States
(12) Patent Application Publication
(10) Pub. No.: US 2022/0250567 A1
(43) Pub. Date: Aug. 11, 2022

(54) OFF-ROAD RECOVERY STORAGE BUMPER

(71) Applicant: Trenton Walker Word, Flowery Branch, GA (US)

(72) Inventor: Trenton Walker Word, Flowery Branch, GA (US)

(21) Appl. No.: 17/173,210

(22) Filed: Feb. 11, 2021

(51) Int. Cl. B60R 19/48; B60R 19/02

(52) U.S. Cl. CPC B60R 19/48; B60R 19/023

(57) ABSTRACT

The “OFF-ROAD RECOVERY STORAGE BUMPER” is designed to provide maximum function with no damage to the frame of the vehicle. The bumper provides storage for an off-road recovery jack as well as a heavy-duty drawer for additional tools or gear. There are many other ways to mount a recovery jack on a jeep or other vehicle, but this gives a way to utilize the space in the bumper without having to make permanent changes to the vehicles body or frame. The “OFF-ROAD RECOVERY STORAGE BUMPER” is a complete replacement for the OEM bumper.

### CROSS-REFERENCE TO RELATED APPLICATIONS

(Not Applicable)

### BACKGROUND OF THE INVENTION

The “OFF-ROAD RECOVERY STORAGE BUMPER” is a rear bumper for a vehicle. I own a Jeep Wrangler and wanted to mount the off-road recovery jack on the vehicle without modifying the vehicle body. Many mounts for this jack require modifying the vehicle permanently, or do not provide good accessibility to the jack. I conceived the “OFF-ROAD RECOVERY STORAGE BUMPER” and created a working model as a direct response to this problem. A working model, by reason of its visibility, tangibility, and operability, makes it easier for anyone who may become interested in the idea to have a clearer understanding of its concept and purpose. No attempts have been made to market or manufacture the “OFF-ROAD RECOVERY STORAGE BUMPER.”

### BRIEF SUMMARY OF THE INVENTION

The concept of “OFF-ROAD RECOVERY STORAGE BUMPER” is a rear bumper for a Jeep Wrangler (or any other off-road vehicle) that neatly stores an off-road recovery jack and other recovery supplies. It provides quick and convenient access to the jack when needed in an emergency and without any body modifications required to the vehicle for installation. This invention would serve as a complete replacement for the original factory rear bumper on a Jeep Wrangler (or any other off-road vehicle). The narrow end of the long jack would be slid inside the right end of the hollow bumper. This would position the larger bottom or base of the jack towards the right end of the bumper where it will be retained into position. Once installed with the jack secured on the inside, the vehicle would be operated in typical fashion. The back bumper would provide crash protection while doubling as a convenient storage unit for the jack. This would ensure the jack is always readily available if needed and without any permanent body damage being inflicted upon the Wrangler (or any other off-road vehicle).

### BRIEF DESCRIPTION OF THE SEVERAL VIEWS OF THE DRAWING

FIG. 1 is an orthographic view of the OFF-ROAD RECOVERY STORAGE BUMPER.

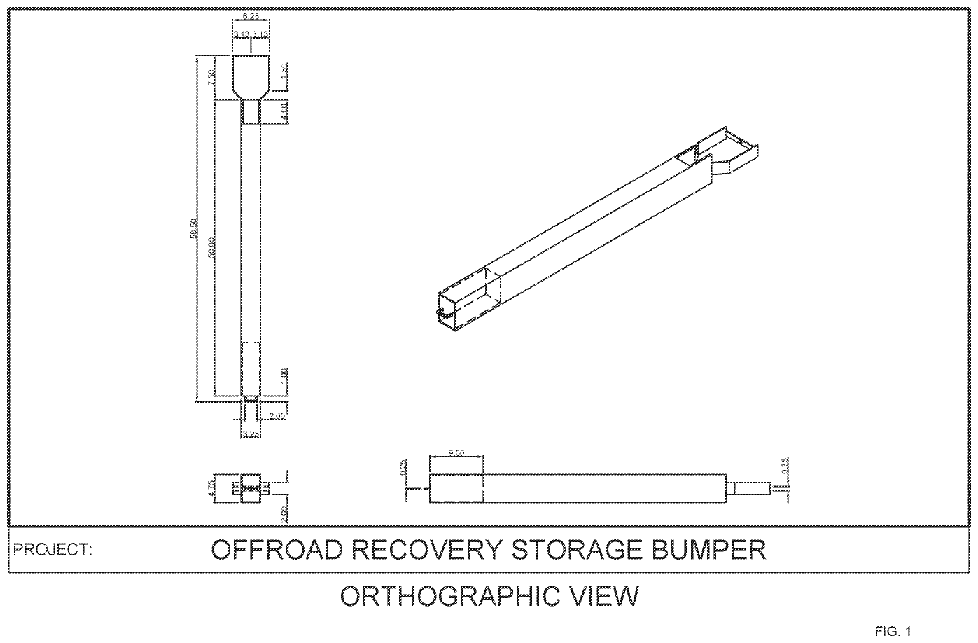

FIG. 1A is an isometric view of the OFF-ROAD RECOVERY STORAGE BUMPER.

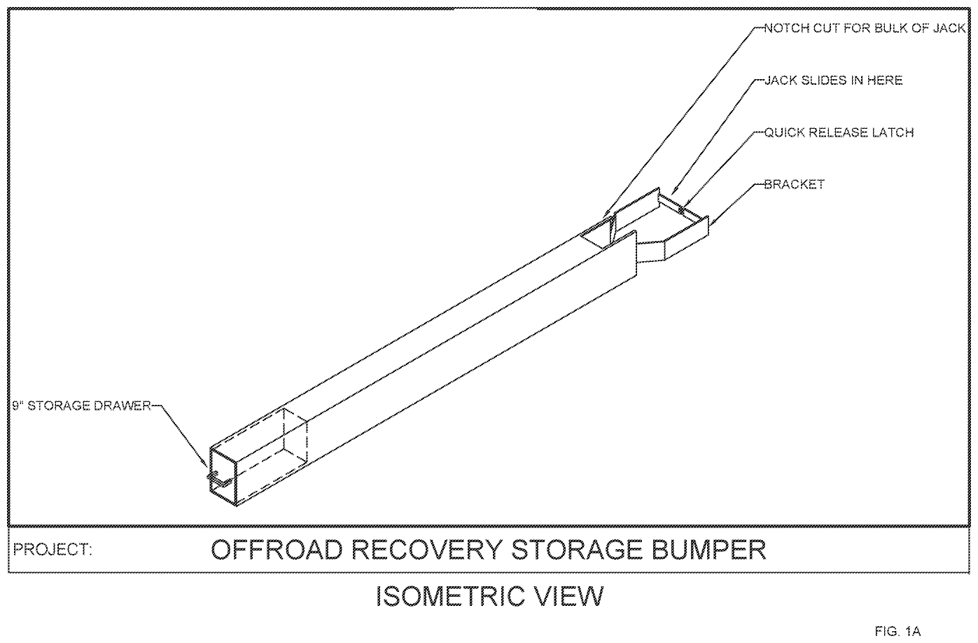

FIG. 1B is a top view of the OFF-ROAD RECOVERY STORAGE BUMPER.

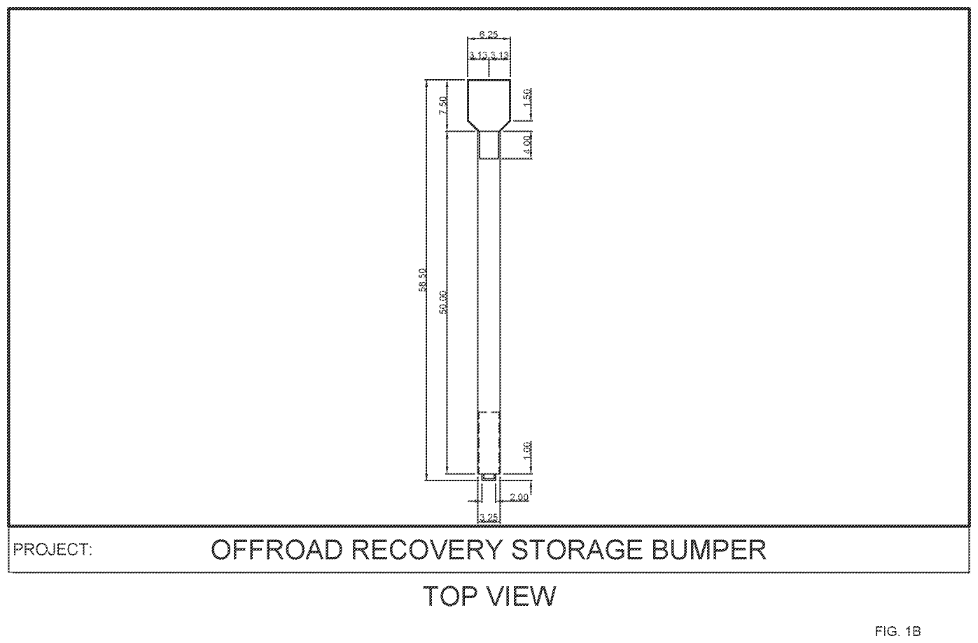

FIG. 1C is a front view of the OFF-ROAD RECOVERY STORAGE BUMPER.

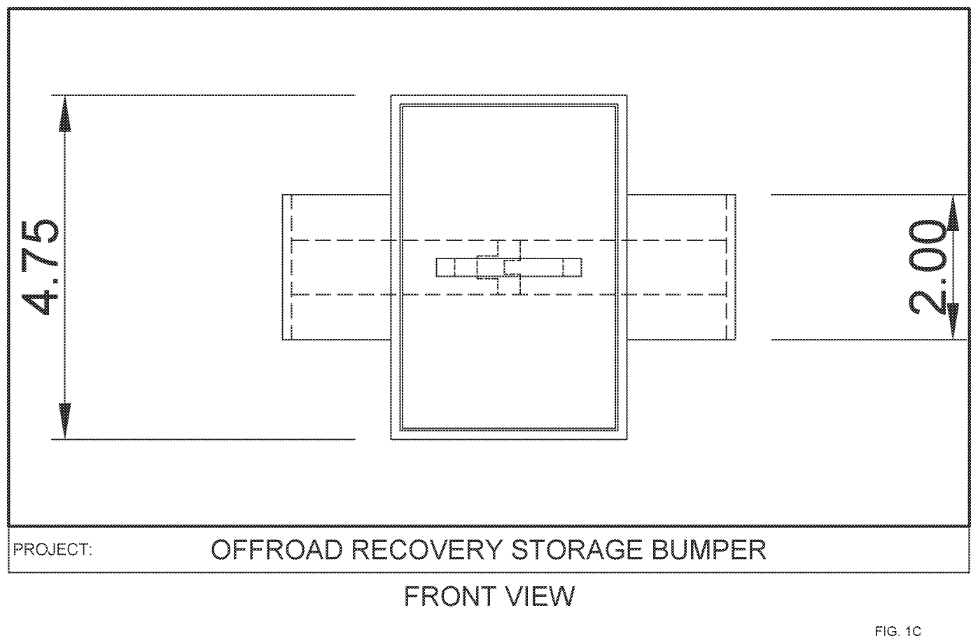

FIG. 1D is a side view of the OFF-ROAD RECOVERY STORAGE BUMPER.

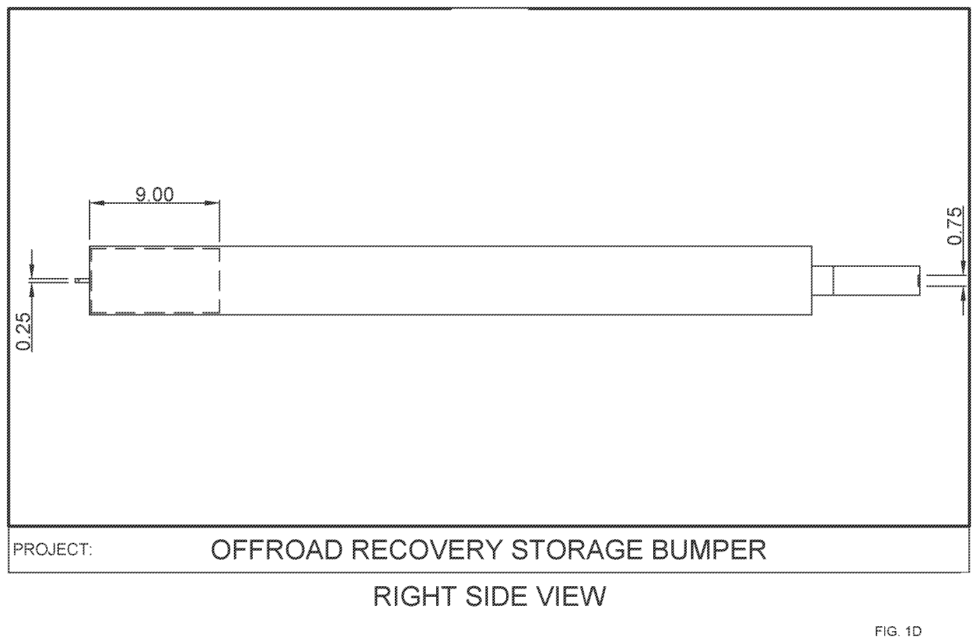

### DETAILED DESCRIPTION OF THE INVENTION

The “OFF-ROAD RECOVERY STORAGE BUMPER” is made to store an off-road recovery jack and other recovery equipment. It is made as long as the vehicle and as tall and wide as the jack. The bumper is mounted to the vehicle the same way as the OEM bumper. The jack is slid in the bumper from the side and is retained by two brackets that wrap around the bulky end of the jack. The remaining room on the other side of the bumper is taken up by a heavy-duty drawer to hold any tools, hooks, rope, and any other recovery equipment.

To secure the jack inside the bumper, it is slid in from the side and secured by a simple hand release lockable latch attached to the retaining bracket that needs to be latched and locked. To remove the jack from the bumper, release the lockable latch and slide it out the opposite of how it went in. The storage drawer is simply a drawer with the capability of being locked.

1. A bumper with the function (or purpose) of storing an off-road recovery jack.

2. A bumper as in claim 1, wherein said bumper comprises of:
a long middle portion;
a drawer with optional lock on one side; and
a bracket and latch retaining system with optional lock on the other side.
